(19) United States
(12) Patent Application Publication
(10) Pub. No.: US 2008/0288388 A1
(43) Pub. Date: Nov. 20, 2008

(54) Method of Conducting a Due Diligence Procedure in a Business Transaction

(76) Inventor: John Michael EDISON, North Potamac, MD (US)

Correspondence Address: Novak Druce & Quigg LLP, 1300 I Street NW, Suite 1000 West Tower, Washington, DC, 20005, US

(21) Appl. No.: 12/144,320

(22) Filed: Jun. 23, 2008

Related U.S. Application Data
(63) Continuation-in-part of application No. 10/621,408, filed on Jul. 18, 2003, now Pat. No. 7,392,203.

(51) Int. Cl. G06Q 40/00; G06Q 99/00

(52) U.S. Cl. 705/35; 705/1

(57) ABSTRACT

A method of conducting a due diligence procedure of a contemplated, continuing or follow-up business transaction between first and second parties generally consisting of devising a list of inquiries, assigning values to such inquiries, establishing levels of risk exposure due to each response to such inquiries, eliciting responses to such inquiries and the assignment of a level of risk exposure to each of such responses, and evaluating the relevant risk exposure in proceeding with such transaction by a consideration of the values assigned to such inquiries and the assigned levels of risk exposure to responses to such inquires.

### CROSS-REFERENCE TO RELATED APPLICATION

This is a continuation-in-part of U.S. patent application Ser. No. 10/621,408, filed Jul. 18, 2003, which is incorporated herein by reference in its entirety.

### FIELD OF THE INVENTION

This invention relates to a method of doing business and more particularly to a method of conducting a due diligence procedure in contemplation of entering into, continuing or following-up on a business transaction.

### BACKGROUND OF THE INVENTION

In certain business transactions between an entity such as a financial institution and a vendor of goods and/or services such as a cash manager, it often is desirable that the entity conduct a due diligence procedure to determine the suitability of the vendor in rendering such goods and/or services. Such suitability could include such aspects of the organization and operation of the vendor as its legal standing as an entity, financial condition, creditworthiness, trustworthiness, reputation, internal controls, compliance with state and federal laws, rules and regulations, attentiveness to security measures, insurability and the like.

Typically, it has been the practice of many entities contemplating entering into a business transaction with a prospective vendor to conduct their own due diligence with respect to determining the suitability of such a vendor. Such practice, however, has been found to be time consuming, costly and often inadequate, diverting personnel from other preferred functions. Accordingly, it is the principal object of the present invention to provide a method permitting an entity seeking to conduct a due diligence of a prospective vendor, to outsource such procedure.

### SUMMARY OF THE INVENTION

The principal object of the present invention is achieved by providing a method of conducting a due diligence procedure of a contemplated business transaction between a first party and a designated second party, generally consisting of devising a list of inquiries concerning the second party, potentially impacting the contemplated transaction, by a third party; assigning a value to each of such inquiries commensurate to the perceived degree of risk exposure attendant to the subject thereof, by the third party; establishing levels of risk exposure assignable by the first party to each response to such inquiries, by the third party, eliciting responses to such inquiries and the assignment of a level of risk exposure to each response to such inquires, from the first party by the third party, evaluating the relative risk exposure in proceeding with the contemplated transaction on the basis of a consideration of the established values of such inquiries and the assignment of a level of risk exposure to each response to such inquiries, by the third party; and reporting such evaluation of relative risk exposure to the first party, by the third party.

In a modification of the method described, responses to the inquires are elicited directly from a designated, potential second party by the third party, and then submitted to the first party for the assignment of the levels of risk exposure to each response. In a further modification of the method described, responses to such inquiries are elicited from an undesignated, potential second party, by the third party, and upon notification by the first party to the third party of an interest of the first party in the undesignated, potential second party, the inquiries and responses of the previously undesignated, potential seemed party are submitted to the first party for the assignment of the level of the risk exposure to each such response.

### BRIEF DESCRIPTION OF THE DRAWINGS

FIG. 1 is a flow diagram depicting several embodiments of the invention.

### DETAILED DESCRIPTION OF THE PREFERRED EMBODIMENTS OF THE INVENTION

The present invention contemplates the outsourcing by a party contemplating entering into a business transaction with a prospective vendor, to a service provider, of a due diligence exercise of such a vendor, by the service provider. Such due diligence requires an investigation of certain aspects of the structure, operation and performance of the prospective vendor, and an evaluation of the information derived from such an investigation. The investigation consists of an inquiry regarding such matters as the legal form and standing of the vendor, its financial condition, reputation, creditworthiness, trustworthiness, the nature of the goods sold and/or services rendered, its general contract terms and conditions, the quality of service rendered, the security measures adopted, its internal controls, insurance coverage, compliance with federal and state laws, rules and regulations, contract termination policies, internet proficiency and accessibility and the like.

In each of the embodiments of the invention, the service provider engaged by a subscriber would prepare a list of inquires pertinent to the aforementioned matters which would relate to the suitability of the vendor, and assign a value, typically a numerical value, to each of such inquiries commensurate with the degree of susceptible risk exposure attributable to each of such areas of inquiry. Such inquires could vary from business to business and further vary over a period of time. The service provider further would devise certain levels of risk exposure due to responses to such inquiries, such as none, low, medium and high, and assign certain values to such levels, typically numerical values. In addition, the service provider would evaluate the risk exposure of the prospective vendor on the basis of the responses to the inquires, values assigned to such inquiries, the levels of risk exposure due to responses to such inquiries and the values assigned to such levels, and report a relative risk exposure to the subscriber. By subscribing to such service of the service provider and obtaining such an evaluation report from the service provider with respect to a contemplated transaction with a prospective vendor, the subscriber would have complied with its obligation of conducting a due diligence exercise in contemplation of entering into a transaction with the prospective vendor.

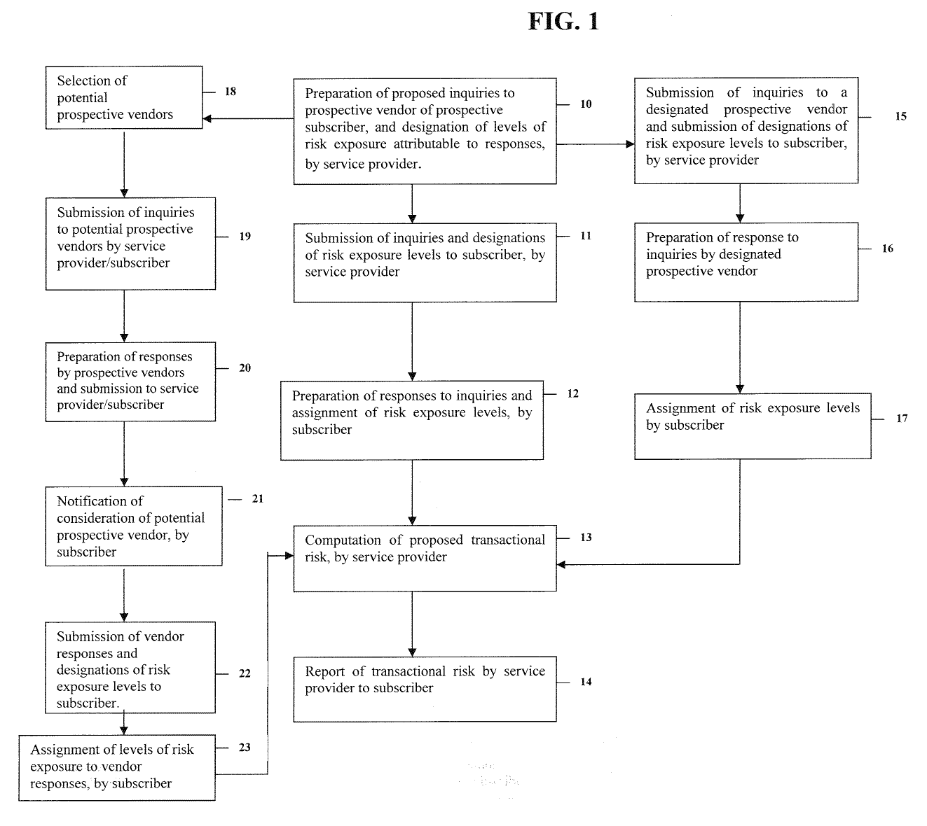

In one embodiment of the invention as indicated in steps 10 through 14 of the flow diagram shown in FIG. 1, initially, a service provider would prepare a proposed set of inquiries to a prospective vendor of a prospective subscriber, and formulate certain risk exposure levels attributable to responses to such inquiries. Upon request of a subscriber, the service provider would submit such set of inquires along with the designations of risk exposure levels to the subscriber, requesting such subscriber obtain responses to such inquiries and assign a level of risk exposure with respect to each response to such inquiries. The subscriber would then undertake to obtain answers to the inquiries by providing them itself, obtaining them from the prospective vendor and/or obtain them from other parties, and designate a level of risk exposure with respect to each of such responses. The responses to such inquiries and the designations of the levels of risk exposure would then be submitted to the service provider which would evaluate the risk exposure of the prospective vendor by considering the values assigned to the inquiries by the service provider and the assigned values of the levels of risk exposure designated by the subscriber. In one such determination, the service provider would multiply the value of each inquiry by the value of the level of risk exposure designated by the subscriber to the response to such inquiry, add the products of such multiplications together and then compare such sum with a maximum number. Upon determining such evaluation, the evaluation would be reported to the subscriber. On the basis of such evaluation, the subscriber would decide on whether or not to proceed with the contemplated transaction with the vendor. In a variation of such method, the service provider would designate the level of risk exposure to each of the responses to the inquiries.

In subscribing to such service of the service provider, the subscriber will have been deemed to have exercised due diligence in proceeding to enter into the contemplated transaction with the vendor. In the event the contemplated transaction between the subscriber and the prospective vendor would extend over a period of time or might be interrupted and then resumed, such procedure as described could be periodically repeated to assure the continued exercise of due diligence. In addition, over such period of time, as conditions or previous results might dictate, the service provider might modify the inquiries to be propounded and the value assigned to each of such inquiries.

In circumstances where the first party has a rule compliance person on its staff, it would be recommended that a person other than the compliance person assemble the responses to the inquiries and the compliance person determine the level of risk due to each response to such inquiries.

In another embodiment of the invention as set forth in steps 10, 15 through 17, 13 and 14 of the flow diagram shown in FIG. 1, the procedure would be similar to the procedure described but instead of the inquiries and the designations of risk exposure levels being submitted to the subscriber for the submission of the inquiries by the subscriber to the prospective vendor, the inquires would be submitted directly to the designated prospective vendor by the service provider and the designations of risk exposure levels would be submitted by the service provider to the subscriber. The designated prospective vendor would then provide the responses to the inquiries to the subscriber, the subscriber would assign the levels of risk exposure to each of the responses provided by the prospective vendor and then the subscriber would submit the responses to the inquires made by the prospective vendor and the designations of levels of risk exposure assigned by the subscriber, to the service provider. The service provider would then make the evaluation as previously described, and report the evaluation back to the subscriber. Here again, if the contemplated transaction is intended to extend over a period of time or the transaction may be interrupted and then resumed, the procedure may be repeated and the inquiries may be modified in response to changing conditions. Also in a variation of this embodiment, the service provider would designate the level of risk exposure to each of the responses to such inquiries.

In still another embodiment of the invention as set forth in steps 10, 18 through 23, 13 and 14 of the flow diagram show in FIG. 1, a set of inquiries as described would be submitted to a selected number of potentially participating vendors by the service provider or subscriber, requesting that they respond to such inquiries in connection with their possible involvement in a transaction with one of the subscribers of the service provider. Upon receipt of the responses of such a potentially participating vendor, such responses would be stored in a database of the service provider. Then, in the event of a notification of a subscriber of the service provider of such subscriber's contemplation of entering into a transaction with such a vendor, and assuming the stored responses of such vendor are sufficiently current, the service provider would submit such responses of such vendor to the inquiring subscriber along with a designation of the risk exposure levels. The subscriber or the service provider would then assign a level of risk exposure due to each of the responses of the vendor, and return such designations to the service provider. The service provider would then proceed to evaluate the risk exposure and report the results to the inquiring subscriber.

In the previously described embodiment, requests for periodic updates of responses to such inquiries would be made to each of such potentially participating vendors, particularly if a vendor was retained by a subscriber. In addition, the substance of the inquiries submitted to such potentially participating vendors would be updated or modified to respond to changing conditions.

In The services provided by the service provider as described, would be offered under a fee arrangement, either under an annual subscription arrangement or on an individual request basis.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

What is claimed is:

1. A method of conducting a due diligence procedure of a contemplated transaction between a first party and a designated second party, comprising:
devising a list of inquiries concerning said second party, potentially impacting said transaction, by a third party;
assigning a value to each of said inquiries commensurate to the perceived degree of risk exposure attendant to the subject matter thereof, by said third party;
designating levels of risk exposure assignable by said first party to each response to said inquiries, by said third party;
eliciting responses to said inquiries and the assignment of a level of risk exposure to each response to said inquiries, from said first party by said third party;
evaluating the relative risk exposure in proceeding with said transaction on the bases of a consideration of said established values of said inquiries and the assignment of a level of risk exposure to each response to said inquiries, by said third party; and
reporting said evaluation of relative risk exposure to said first party by said third party.

2. A method according to claim 1 wherein the substance of said inquiries includes at least one of the legal form and standing, financial condition, reputation, creditworthiness, trustworthiness, product and/or services, general contract terms and conditions, quality of service, security measures, internal controls, insurance coverage, compliance with federal and state laws, rules and regulations, contract termination policies and internet accessibility of said second party.

3. A method according to claim 1 wherein said levels of risk exposure comprise none, low, medium and high.

4. A method according to claim 1 including assigning numerical values to said inquiries commensurate to their propensity for risk, and to said levels of risk exposure.

5. A method according to claim 4 including computing a risk exposure factor of said transaction by multiplying the numerical value of each said inquiries by the numerical value of the level of risk exposure indicated in the response to said inquiry, adding the products of said multiplications and comparing the sum thereof with one of a maximum and minimum value.

6. A method according to claim 1 wherein said method is repeated periodically.

7. A method according to claim 1 wherein said inquiries are responded to by a first person of said first party and said levels of risk exposure are determined by a second person of said first party.

8. A method according to claim 7 wherein said second person of said first party comprises a rule compliance person.

9. A method according to claim 1 including subsequent to eliciting responses to said inquiries from said first party by said third party, eliciting responses to said inquiries from said second party by said first party, reevaluating the relative risk exposure on the basis of a consideration of said assigned values and predetermined levels of risk exposure and reporting said evaluation risk exposure by said third party to said first party

10. A method according to claim 9 including applying the levels of risk exposure determined by said first party.

11. A method according to claim 1 including offering a service involving said method by said third party for a fee payable by said first party.

12. A method of conducting a due diligence procedure of a contemplated transaction between a first party and a designated second party comprising:
devising a list of inquiries concerning said second party, potentially impacting said transaction, by a third party;
assigning a value to each of said inquiries commensurate to a perceived degree of risk exposure attendant to the subject matter theory, by said third party;
designating levels of risk exposure assignable by said first party to each response to said inquiries, by said third party eliciting responses to said inquiries from said second party, by said third party;
submitting said responses from said second party and said levels of risk exposure to said first party, by said third party;
eliciting an assignment of a level risk exposure to each of said responses to said inquiries from said first party by said third party;
evaluating the relative risk exposure in proceeding with said transition on the basis of a consideration of said establishment values of said inquiries and the assignment of a level of risk exposure to each response to said inquires, by said third party; and
reporting said evaluation of relative risk exposure to said first party by said second party.

13. A method according to claim 12 including assigning numerical values to said inquiries commensurate to their propensity for risk exposure, and to said levels of risk exposure.

14. A method according to claim 13 including computing a risk factor of said transactions by multiplying the value of each said inquiries by the value of the level of risk exposure designated for the response to said inquiry, adding the products of said multiplications and comparing the sum thereof with one of a maximum and minimum value.

15. A method according to claim 12 wherein said method is repeated periodically.

16. A method according to claim 12 including conducting said method by said third party for a fee payable by said first party.

17. A method according to claim 11 wherein said method is conducted pursuant to a subscription arrangement.

18. A method according to claim 1 including devising more than one list of inquiries, applicable to different types of businesses.

19. A method according to claim 1 wherein said first party comprises a financial institution, said second party comprises a vendor in the business of rendering goods and/or services to a financial institution and said third party is a service provider.

20. A method of conducting a due diligence procedure of a prospective transaction between a first party and an undesignated, potential second party comprising:
devising a list of inquiries concerning said second party, potentially impacting said transaction, by a third party;
assigning a value to each of said inquiries commensurate to a perceived degree of risk exposure attendant to the subject matter thereof, by said third party;
designating levels of risk exposure assignable by said first party to each response to said inquiries, by said third party;
eliciting responses to said inquiries from said second party, by said third party;
storing said inquiries and responses of said second party in a database, by said third party;
retrieving said inquiries and responses of said second party from said database by said third party, upon notification by said first party to said third party of the identification of said second party as a party to a contemplated transaction between said first and second parties;
submitting said retrieved inquiries and responses of said second party to said first party, along with said designated levels of risk exposure, by said third party, eliciting the assignment of a level of risk exposure to each of said responses to said inquiries;
evaluating the relative risk exposure in proceeding with said transaction on the bases of a consideration of said established values of said inquiries and the assignment of level of risk exposure to each response to said inquiries, by said third party; and
reporting said evaluation of relative risk exposure to said first party by said third party.

21. A method according to claim 20 wherein the substance of said inquiries includes at least one of the legal form and standing, financial condition, reputation, creditworthiness, trustworthiness, product and/or service, general contract terms and conditions, product and/or service, general contract terms and conditions, quality of service, security measures, internal controls, insurance coverage, compliance with federal and state laws, rules and regulations, contract termination policies and internet accessibility of said second party.

22. A method according to claim 20 wherein said levels of risk exposure comprise none, low, medium and high.

23. A method according to claim 20 including assigning numerical values to said inquiries commensurate to their propensity to risk exposure, and to said levels exposure of risk.

24. A method according to claim 23 including computing a risk factor of said transactions by multiplying the numerical value of each of said inquiries by the numerical value of the level of risk exposure assigned to the response to said inquiry, adding the products of said multiplications and comparing the sum thereof with one of a maximum and minimum value.

25. A method according to claim 20 including conducting said method periodically.

26. A method according to claim 1 wherein said third party assigns a level of risk exposure to each response to said inquiries in lieu of said first party.
